(19) United States
(12) Patent Application Publication
(10) Pub. No.: US 2008/0108318 A1
(43) Pub. Date: May 8, 2008

(54) ULTRA LOW-POWER WAKE-UP RECEIVER

(75) Inventors: Sang Hyun MIN, GYUNGGI-DO (KR); Joong Jin KIM, GYUNGGI-DO (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/934,526

(22) Filed: Nov. 2, 2007

(30) Foreign Application Priority Data
Nov. 3, 2006 (KR) 10-2006-108554

(51) Int. Cl. H04B 1/16

(52) U.S. Cl. 455/343.1

(57) ABSTRACT

Provided is an ultra low-power wake-up receiver capable of reducing an operating time of an analog receiver by controlling operation on/off of the analog receiver according to a clock signal from a digital receiver in an amplitude-shift keying (ASK) or on-off keying (OOK) radio receiver. The ultra low-power wake-up receiver includes: a clock generator generating a clock signal having a predetermined frequency; an operation controller controlling analog operation-on for a predetermined time according to the clock signal from the clock generator; an analog receiver maintaining an operation-on state for a predetermined time according to the analog operation-on control performed by the operation controller, and being operated off after the predetermined time; and a digital receiver being operated on while the analog receiver maintains the operation-on state

### CROSS-REFERENCE TO RELATED APPLICATIONS

This application claims the priority of Korean Patent Application No. 2006-108554 filed on Nov. 3, 2006 in the Korean Intellectual Property Office, the disclosure of which is incorporated herein by reference.

### BACKGROUND OF THE INVENTION

1. Field of the Invention

The present invention relates to an ultra low-power wake-up receiver applied to an amplitude-shift keying (ASK) or on-off keying (OOK) radio receiver, and more particularly, to an ultra low-power wake-up receiver capable of significantly reducing power consumption by controlling operation on/off of an analog receiver according to a clock signal from a digital receiver to reduce an operating time of the analog receiver in the ASK or OOK radio receiver.

2. Description of the Related Art

Recently, research on an ultra low-power radio or a radio wake-up system for increasing an operation life-span of a wireless personal area network (WPAN) or a sensor network device has been carried out all over the world.

Most of the research is focused on an ultra low-power radio circuit or device. However, research for reducing power consumption in terms of signal processing has to be studied and developed.

FIG. 1 is a view illustrating a configuration of a general radio receiver.

The general radio receiver illustrated in FIG. 1 includes a wake-up receiver 10 for receiving a signal from an antenna ANT, determining whether or not the received signal is a wake-up signal, and outputting a wake-up notification signal when the received signal is the wake-up signal, a main receiver 20 for waking up when receiving the wake-up notification signal from the wake-up receiver 10 to receive a signal through the antenna ANT, and a microprocessor 30 for processing a signal received from the main receiver 20.

The wake-up receiver 10 wakes the main receiver 20 up when receiving the wake-up signal. The wake-up receiver 10 has a configuration as illustrated in FIG. 2.

FIG. 2 is a view illustrating the configuration of the wake-up receiver according to a related art.

The wake-up receiver 10 according to the related art illustrated in FIG. 2 includes a power supply 11 for supplying an operation power, an analog receiver 12 for performing amplification and frequency conversion on a radio frequency (RF) signal received through the antenna ANT to convert the RF signal into a baseband signal and performing analog to digital (A/D) conversion on the baseband signal so as to be output, a clock generator 13 for generating a clock signal, and a digital receiver 14 for detecting data by performing synchronization acquisition of a signal received from the analog receiver 12 according to the clock signal from the clock generator 13 and various signal processing operations.

In order to receive the wake-up signal, the analog receiver 12 has to be always powered on. Operation timing of the wake-up receiver 10 is described with reference to FIG. 3.

FIG. 3 is an operation timing chart of the wake-up receiver 10 illustrated in FIG. 2.

Referring to FIG. 3, the analog receiver 12 is always powered on while receiving signals, so that the analog receiver 12 receives a continuous analog signal with respect to a time before performing A/D conversion. Thereafter, the analog receiver 12 converts the analog signal into digital data by performing positive edge synchronization according to an operation clock (or sampling clock) of the digital receiver 14 and outputs the digital data to the digital receiver 14 as illustrated in FIG. 2.

In this case, although the conventional wake-up receiver uses only data values at positive edges to perform A/D conversion, analog data exists during the remaining time, so that the analog receiver unnecessarily operates and this results in waste of energy.

The general radio receiver allows an analog circuit to be always powered on while receiving a signal. However, since digital circuits practically use only analog data at sampling times synchronized with a clock and do not use analog data existing during the remaining time, a large amount of energy is wasted.

### SUMMARY OF THE INVENTION

An aspect of the present invention provides an ultra low-power wake-up receiver capable of significantly reducing power consumption by controlling operation on/off of an analog receiver according to a clock signal from a digital receiver to reduce an operating time of the analog receiver in an amplitude-shift keying (ASK) or on-off keying (OOK) radio receiver.

According to an aspect of the present invention, there is provided an ultra low-power wake-up receiver including: a clock generator generating a clock signal having a predetermined frequency; an operation controller controlling analog operation-on for a predetermined time according to the clock signal from the clock generator; an analog receiver maintaining an operation-on state for a predetermined time according to the analog operation-on control performed by the operation controller, and being operated off after the predetermined time; and a digital receiver being operated on while the analog receiver maintains the operation-on state.

In the above aspect of the present invention, the ultra low-power wake-up receiver may further include a delay unit delaying the clock signal from the clock generator for a predetermined delay time to output a delay clock signal.

In addition, the operation controller may control the analog operation-on according to the clock signal from the clock generator and control analog operation-off according to the delay clock signal from the delay unit.

In addition, the analog receiver may be operated on before a time point when the digital receiver is operated on and operated off after the time point when the digital receiver is operated on, according to the analog operation-on control performed by the operation controller.

In addition, the digital receiver may be operated on after a time point when the analog receiver is operated on and before a time point when the analog receiver is operated off, according to the delay clock signal from the delay unit.

In addition, the operation controller may control the operation-on of the analog receiver at a positive edge of the clock signal from the clock generator and control the operation-off of the analog receiver at a positive edge of the delay clock signal from the delay unit.

In addition, the delay unit may include: a first delay unit delaying the clock signal from the clock generator for a first predetermined delay time to output a first delay clock signal; and; and a second delay unit delaying the first delay clock signal from the first delay unit for a second predetermined delay time to output a second delay clock signal.

In addition, the operation controller may control the operation-on of the analog receiver at a positive edge of the clock signal from the clock generator and control the operation-off of the analog receiver at a positive edge of the second delay clock signal from the delay unit.

In addition, the digital receiver may operate according to the first delay clock signal from the delay unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a configuration of a general radio receiver;

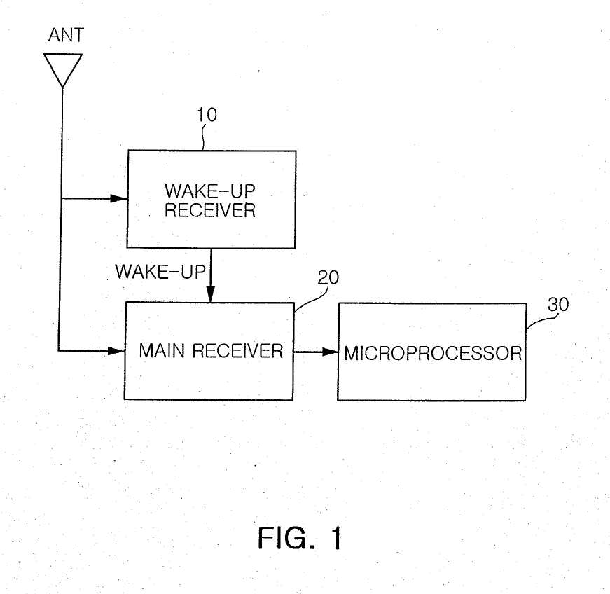

FIG. 2 is a view illustrating a configuration of a wake-up receiver according to a related art;

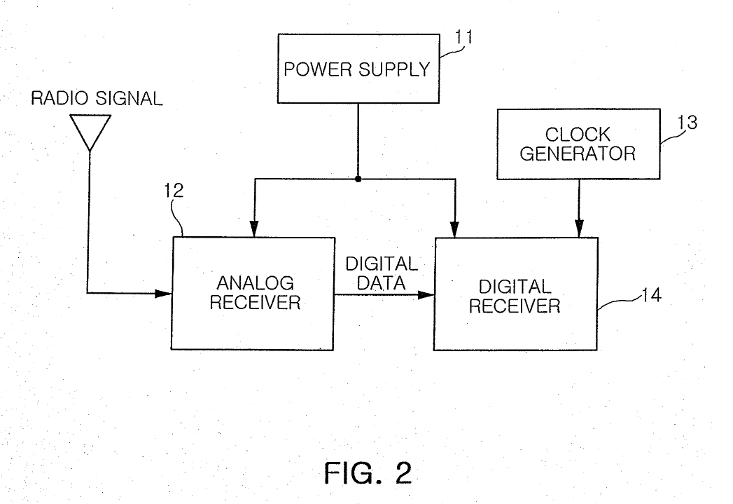

FIG. 3 is an operation timing chart of the wake-up receiver illustrated in FIG. 2;

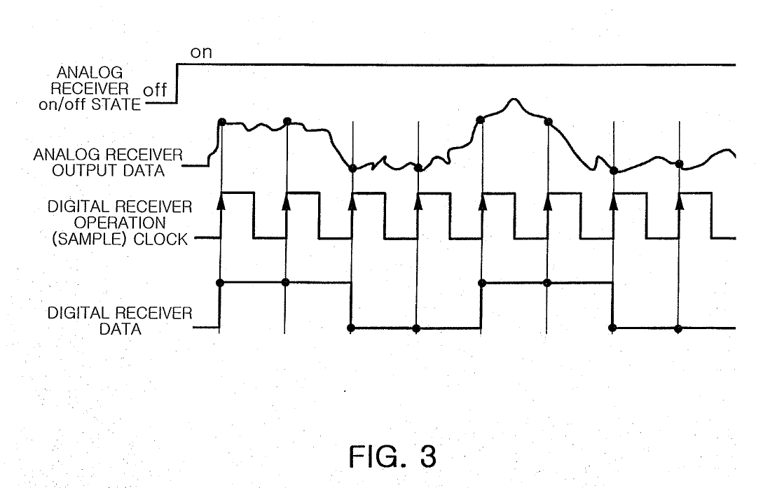

FIG. 4 is a view illustrating a configuration of a wake-up receiver according to an embodiment of the present invention; and

FIG. 5 is an operation timing chart of the wake-up receiver illustrated in FIG. 4.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements.

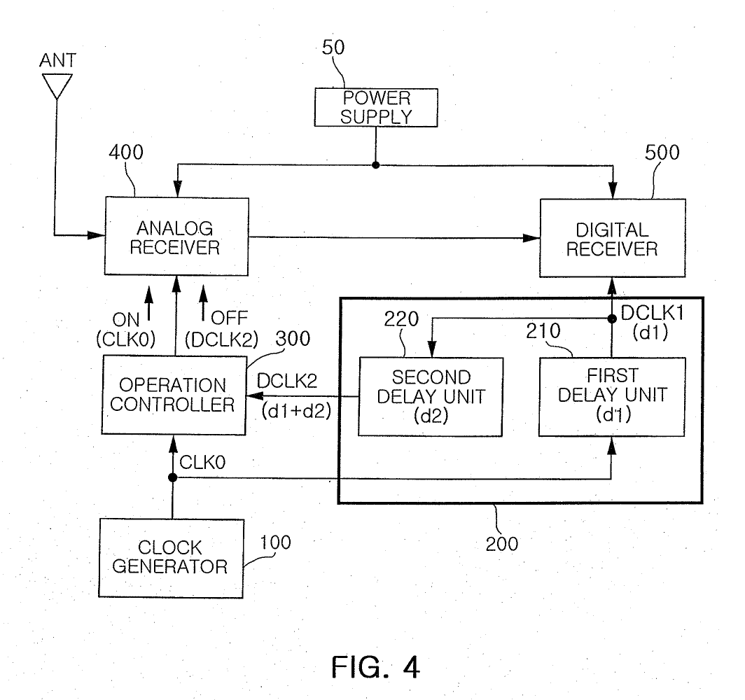

FIG. 4 is a view illustrating a configuration of a wake-up receiver according to an embodiment of the present invention.

Referring to FIG. 4, the wake-up receiver according to the embodiment of the present invention includes a clock generator 100 for generating a clock signal CLK0 having a predetermined frequency, an operation controller 300 for controlling analog operation-on for a predetermined time according to the clock signal CLK0 from the clock generator 100, an analog receiver 400 for maintaining an operation-on state for a predetermined time according to the analog operation-on control performed by the operation controller 300 and being operated off after the predetermined time, and a digital receiver 500 operated on while the analog receiver 400 maintains the operation-on state.

The ultra low-power wake-up receiver may further include a delay unit 200 for delaying the clock signal from the clock generator 100 for a predetermined delay time to output a delay clock signal.

The operation controller 300 controls the analog operation-on according to the clock signal CLK0 from the clock generator 100 and controls analog operation-off according to the delay clock signal from the delay unit 200.

The analog receiver 400 is operated on before a time point when the digital receiver 500 is operated on according to the analog operation-on control performed by the operation controller 300 and is operated off after the time point when the digital receiver 500 is operated on.

The digital receiver 500 is operated on after a time point when the analog receiver 400 is operated on and before a time point when the analog receiver 400 is operated off, according to the delay clock signal from the delay unit 200.

The operation controller 300 controls the operation-on of the analog receiver 400 at a positive edge of the clock signal CLK0 from the clock generator 100 and controls the operation-off of the analog receiver 400 at a positive edge of the delay clock signal from the delay unit 200.

As illustrated in FIG. 4, the delay unit 200 includes a first delay unit 210 for delaying the clock signal CLK0 from the clock generator 100 for a first predetermined delay time d1 to output a first delay clock signal DCLK1 and a second delay unit 220 for delaying the first delay clock signal DCLK1 from the first delay unit 210 for a second predetermined delay time d2 to output a second delay clock signal DCLK2.

Here, the operation controller 300 controls the operation-on of the analog receiver 400 at the positive edge of the clock signal CLK0 from the clock generator 100 and controls the operation-off of the analog receiver 400 at a positive edge of the second delay clock signal DCLK2 form the delay unit 200.

The digital receiver 500 operates according to the first delay clock signal DCLK1 from the delay unit 200 and is operated on at a positive edge of the first delay clock signal DCLK1.

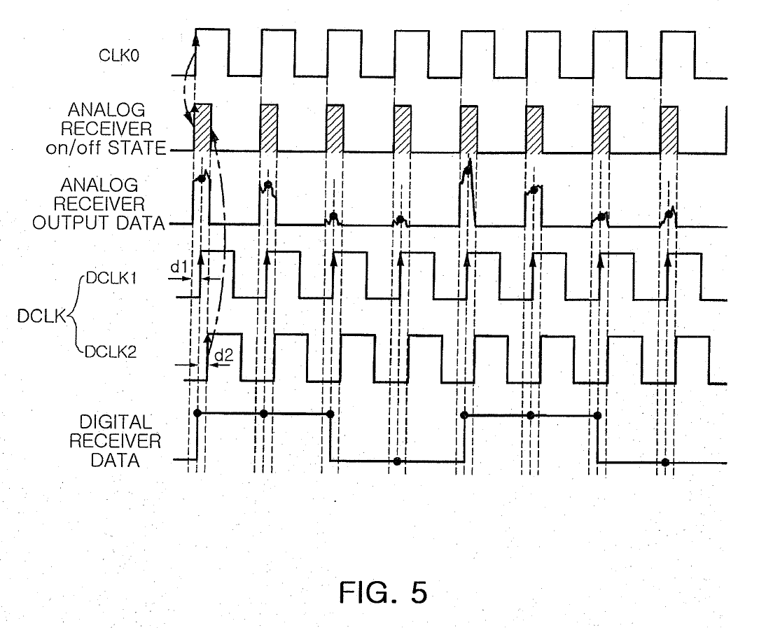

FIG. 5 is an operation timing chart of the wake-up receiver illustrated in FIG. 4.

Referring to FIG. 5, a signal CLK0 is a clock signal output from the clock generator 100. A signal DCLK is a delay clock signal output from the delay unit 200 and includes a signal DCLK1 that is a first delay clock signal output from the first delay unit 210 of the delay unit 200 and a signal DCLK2 that is a first delay clock signal output from the second delay unit 220 of the delay unit 200.

Hereinafter, operations and effects of the present invention will be described in detail with reference to the attached drawings.

Operations of the wake-up receiver according to the embodiment of the present invention will be described with reference to FIGS. 4 and 5. First, the power supply 50 supplies an operation power to the analog receiver 400 and the digital receiver 500 to normally operate the wake-up receiver according to the embodiment of the present invention.

The clock generator 100 of the wake-up receiver illustrated in FIG. 4 generates and outputs the clock signal CLK0 having a predetermined frequency to the clock signal CLK0 to the delay unit 200 and the operation controller 300.

The delay unit 200 delays the clock signal CLK0 from the clock generator 100 for a predetermined delay time to output a delay clock signals to the analog receiver 400 and the digital receiver 500.

The operation controller 300 controls the analog operation-on of the analog receiver 400 for a predetermine time according to the clock signal CLK0 from the clock generator 100. Accordingly, the analog receiver 400 maintains the operation-on state for the predetermined time according to the analog operation-on control performed by the operation controller 300 and is operated off after the predetermined time.

The digital receiver 500 is operated on for an operation-on maintaining time of the analog receiver 400 according to the delay clock signal from the delay unit 200.

Specifically, the operation controller 300 controls the analog operation-on according to the clock signal CLK0 from the clock generator 100 and controls the analog operation-off according to the delay clock signal from the delay unit 200.

Accordingly, the analog receiver 400 is operated on according to the clock signal CLK0 from the clock generator 100 and operated off according to the delay clock signal from the delay unit 200.

More specifically, the analog receiver 400 is operated on before a time point when the digital receiver 500 is operated on, and operated off after a time point when the digital receiver 500 is operated on, according to the analog operation-on control performed by the operation controller 300.

Accordingly, the digital receiver 500 is operated on after the time point when the analog receiver 400 is operated on and before the time point when the analog receiver 400 is operated off, according to the delay clock signal from the delay unit 200.

For example, referring to FIGS. 4 and 5, in a case where the delay unit 200 includes the first delay unit 210 and the second delay unit 220, the first delay unit 210 of the delay unit 200 delays the clock signal CLK0 from the clock generator 100 for the first predetermined delay time d1 to output the first delay clock signal DCLK1. The second delay unit 220 of the delay unit 200 delays the first delay clock signal DCLK1 from the first delay unit 210 for the second predetermined delay time d2 to output the second delay clock signal DCLK2.

Here, the operation controller 300 controls the operation-on of the analog receiver 400 at the positive edge of the clock signal CLK0 from the clock generator 100 and controls the operation-off of the analog receiver 400 at a positive edge of the second delay clock signal DCLK2 from the delay unit 200.

Accordingly, the analog receiver 400 is operated on before the time point when the digital receiver 500 is operated on, and operated off after the time point when the digital receiver 500 is operated on according to the analog operation-on control performed by the operation controller 300.

In addition, the digital receiver 500 is operated on after the time point when the analog receiver 400 is operated on and before the time point when the analog receiver 400 is operated off, according to the first delay clock signal DCLK1 from the delay unit 200.

Referring to FIG. 5, when the clock generator 100 illustrated in FIG. 4 generates the clock signal CLK0, the clock signal CLK0 initially input to the operation controller 300 turns the analog receiver 400 on at the positive edge time point.

Here, the first delay unit 210 of the delay unit 200 delays the clock signal CLK0 for the first predetermined delay time d2 to output the first delay clock signal DCLK1 to the digital receiver 500, and the digital receiver 500 is operated on at the positive edge time point of the first delay clock signal DCLK1.

In addition, the second delay unit 220 of the delay unit 200 delays the first delay clock signal CLK1 for the second predetermined delay time d2 to output the second delay clock signal DCLK2 to the analog receiver 400, and the analog receiver 400 is operated off at the positive edge time point of the second delay clock signal DCLK2.

As described above, the analog receiver 400 is operated on at the positive edge time point of the clock signal CLK0, maintains the operation-on state until the positive edge time point of the second delay clock signal DCLK2, and is operated off, and during the operation-on period, the analog receiver 400 performs sampling on the analog signal to output the sampled analog signal to the digital receiver 500.

It takes a time for the analog receiver to normally operate after the analog receiver is operated on. Particularly, an analog receiver using a block such as a phase lock loop (PLL) needs much time to normally operate. In addition, in a communication system having a high data transmission rate, a sampling rate increases to perform A/D conversion at the high data transmission rate, and a sample period decreases, so that the time taken for the analog receiver to normally operate after being operated on significantly increases as compared with the sampling period, and the analog receiver cannot be applied to the communication system.

Instead, in a communication system in which an analog receiver such as an amplitude-shift keying (ASK)/on-off keying (OOK) receiver does not need much time to normally operate and the data transmission rate is low, the wake-up receiver according to the embodiment of the present invention can be applied to this communication system. Accordingly, power consumption can be significantly reduced without increasing complexity of the system.

Specifically, a power saving efficiency is calculated as follows. For example, when it is assumed that an analog circuit power consumption is 10 mW during a normal operation and a digital clock period is 50 us (20 kHz), and when the delay times d1 and d2 of the first and second delay units 210 and 220 are about 1 us, respectively, and an operating time of the analog receiver 400 for a period is 2 us, an operating time ratio of the analog receiver is 4% (2 us/50 us=0.04=4%), and the power consumption of the analog receiver according to the present invention for a period is 0.4 mW (=10 mW*0.04).

Accordingly, the analog receiver is operated on at a predetermined time before a data sampling time point for A/D conversion and operated off at a predetermined time after sampling data, so that the analog receiver is operated on for a very short time, and power consumption can be significantly reduced.

In other words, the analog receiver is operated off in remaining intervals except for the sampling time, so that power consumption is minimized.

The wake-up receiver can be applied to a wake-up system or a sensor network receiver in a wireless personal area network (WPAN) requiring ultra low-power communication and a low data rate communication system.

Accordingly, in the ASK or OOK radio receiver, the operating time of the analog receiver is reduced by controlling operation on/off of the analog receiver according to the clock signal from the digital receiver, so that it is possible to significantly reduce power consumption.

While the present invention has been shown and described in connection with the exemplary embodiments, it will be apparent to those skilled in the art that modifications and variations can be made without departing from the spirit and scope of the invention as defined by the appended claims.

What is claimed is:

1. An ultra low-power wake-up receiver comprising:
a clock generator generating a clock signal having a predetermined frequency;
an operation controller controlling analog operation-on for a predetermined time according to the clock signal from the clock generator;
an analog receiver maintaining an operation-on state for a predetermined time according to the analog operation-on control performed by the operation controller, and being operated off after the predetermined time; and
a digital receiver being operated on while the analog receiver maintains the operation-on state.

2. The ultra low-power wake-up receiver of claim 1, further comprising a delay unit delaying the clock signal from the clock generator for a predetermined delay time to output a delay clock signal.

3. The ultra low-power wake-up receiver of claim 2, wherein the operation controller controls the analog operation-on according to the clock signal from the clock generator and controls analog operation-off according to the delay clock signal from the delay unit.

4. The ultra low-power wake-up receiver of claim 3, wherein the analog receiver is operated on before a time point when the digital receiver is operated on and operated off after the time point when the digital receiver is operated on, according to the analog operation-on control performed by the operation controller.

5. The ultra low-power wake-up receiver of claim 4, wherein the digital receiver is operated on after a time point when the analog receiver is operated on and before a time point when the analog receiver is operated off, according to the delay clock signal from the delay unit.

6. The ultra low-power wake-up receiver of claim 2, wherein the operation controller controls the operation-on of the analog receiver at a positive edge of the clock signal from the clock generator and controls the operation-off of the analog receiver at a positive edge of the delay clock signal from the delay unit.

7. The ultra low-power wake-up receiver of claim 2, wherein the delay unit comprises:
a first delay unit delaying the clock signal from the clock generator for a first predetermined delay time to output a first delay clock signal; and
a second delay unit delaying the first delay clock signal from the first delay unit for a second predetermined delay time to output a second delay clock signal.

8. The ultra low-power wake-up receiver of claim 7, wherein the operation controller controls the operation-on of the analog receiver at a positive edge of the clock signal from the clock generator and controls the operation-off of the analog receiver at a positive edge of the second delay clock signal from the delay unit.

9. The ultra low-power wake-up receiver of claim 8, wherein the digital receiver operates according to the first delay clock signal from the delay unit.
